(19) United States
(12) Patent Application Publication
(10) Pub. No.: US 2019/0111780 A1
(43) Pub. Date: Apr. 18, 2019

(54) Automotive drive shaft measuring tool

(71) Applicant: Stephen Don Thomas, Murfreesboro, TN (US)

(72) Inventor: Stephen Don Thomas, Murfreesboro, TN (US)

(21) Appl. No.: 15/732,269

(22) Filed: Oct. 17, 2017

(51) Int. Cl. B60K 17/24; F16D 3/40; B25B 27/06; G01B 21/16

(52) U.S. Cl. CPC B60K 17/24; G01B 21/16; B25B 27/06; F16D 3/405

(57) ABSTRACT

This tool is not found in the industry commercially as of this date. The simplicity of the telescopic design results in a user friendly, simple solution to an otherwise complicated problem.

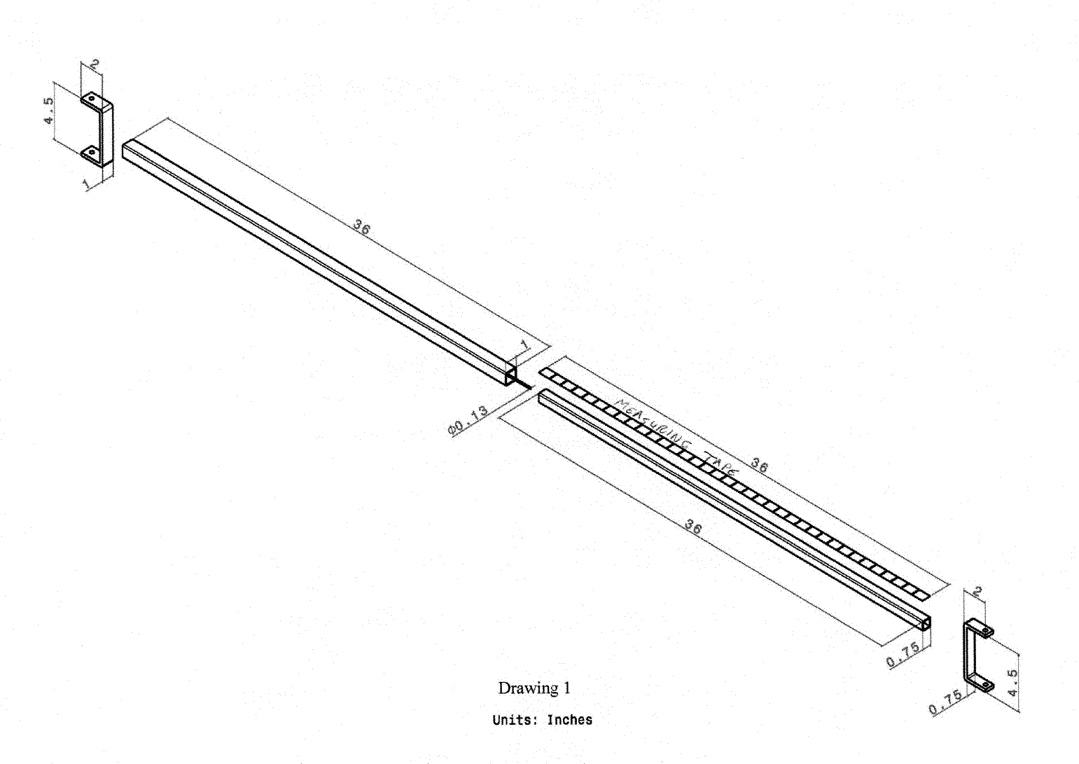

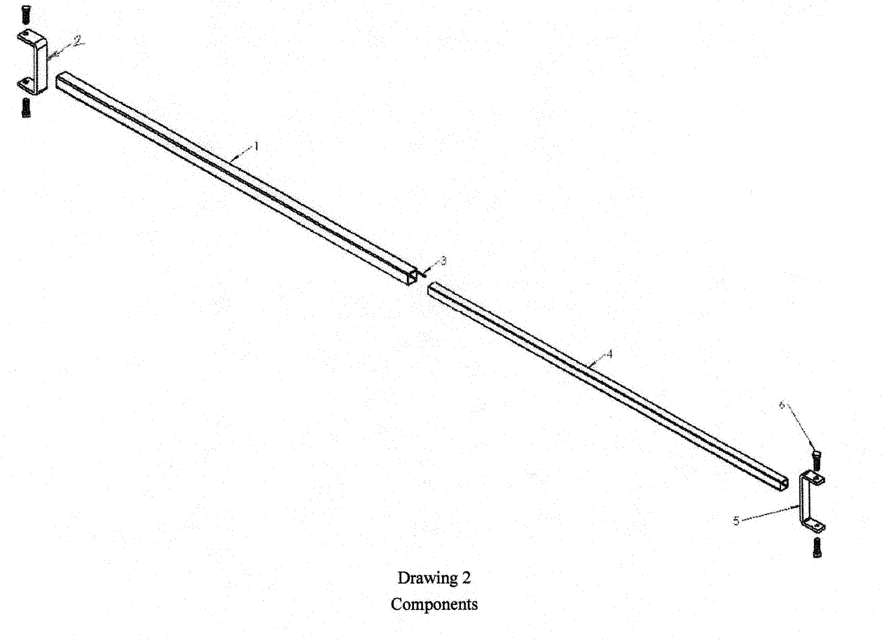

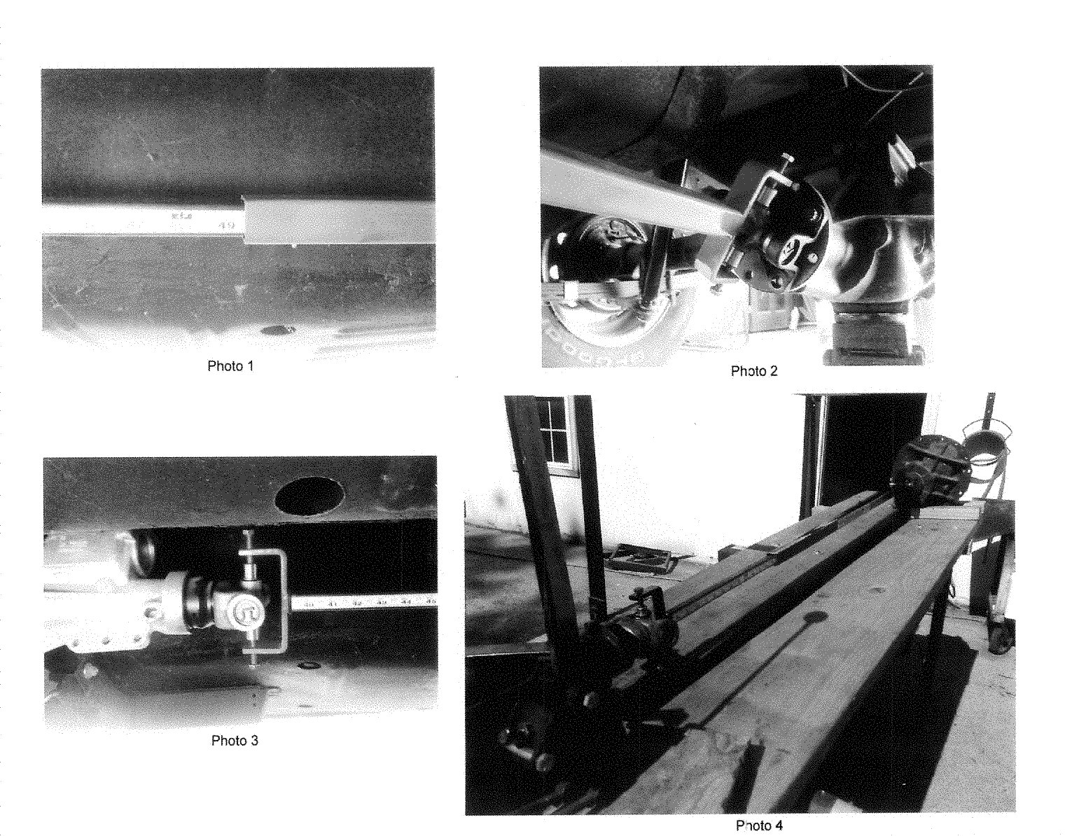

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

This tool pertains to the field of aftermarket automotive customization, an ever growing business in the USA and abroad. This tool removes guesswork in exact length needed from the process of building a custom length drive shaft. This tool was developed from the need for such a tool in my own shop.

### BRIEF SUMMARY OF THE INVENTION

The driveshaft measuring tool is beneficial to automotive fabrication shops and auto enthusiast, 4×4 and Hot Rod builders for the following reasons: It eliminates the need to take three separate measurements currently required in order to determine the exact length of the new drive shaft to be built, which required two people to achieve; this tool allows one person to measure for the drive shaft, thus requiring less labor, or in the instance of a one man shop, he can do it by himself. This tool gives the user the exact center of the front universal joint to the exact center of the rear universal joint measurement from 40 to 74 inches, taking all risk of cutting the driveshaft too short or too long out of the equation. Do it once, do it right.

### BRIEF DESCRIPTION OF THE SEVERAL VIEWS OF THE DRAWINGS

Drawing 1, Dimensional

This drawing shows the dimensions of the individual components used to build the tool. The drawing also includes a view of the 36 inch section of self adhesive tape measure that is used to gauge the length of the drive shaft being measured.

Drawing 2, Components

This drawing shows the components used to build the tool

Item 1: 1 inch stock square tubing

Item 2: 4.5×2×1 inch end

Item 3: ⅛ inch round rod used for spacer

Item 4: 3.75 inch stock square tubing

Item 5: ¼×4.5×2×3.75 inch end

Item 6: Stock hardware 5/16-18×1¼ inch bolt

Not Shown: ½ inch wide self adhesive tape measure section used

### Photos

Photo 1: Point of reference for exact drive shaft measurement, in this case 49% inches center to center of universal joints

Photo 2: Tool in place at rear universal joint

Photo 3: Tool in place at front universal joint

Photo 4: Tool set up in demonstration of use

### DETAILED DESCRIPTION OF THE INVENTION

The Drive Shaft Measuring Tool is constructed of one part being made from ½ inch square tubing, 36 inches long. There is a “horseshoe” end section made with ¼×¾ inch flat steel welded together with tapped holes on each side for the bolts to screw into to attach to the u-joint. This part is then welded to the shaft. This shaft section has a self adhesive tape measure attached to it giving the variable length measurement for the purpose of the tool.

The second part is made from 1 inch square tubing, also 36 inches long, that the first part slides into, resulting in a telescopic apparatus. The end design with the tapped bolt holes is made from 1 inch material and is then welded to the shaft. This section of the tool provides the measuring reference point.

There is a 3/16 rod utilized to take up the slack between the two sizes of tubing, resulting in a tighter, smoother operation. The rod is spot welded at the ends of the tubing to make it a permanent attachment.

### Instructions for Use

NOTICE: You must have on hand the proper transmission slip yoke and u-joints for your application.

Attach slip yoke for the transmission with u-joint installed to the telescopic shaft with the tape measure on it, and rear u-joint to the other end of the Drive Shaft Measuring Tool. Attach by removing the two opposing grease caps on each u-joint, and screw the bolts on both ends of the tool into the open holes provided for grease.

The bolts will self center and hold the u-joints in the proper location for accuracy of measurement (see photo). Place slip yoke into transmission and seat until it stops travel. Extend Drive Shaft Measuring tool toward rear differential and place the rear u-joint in place at rear differential u-joint mounting flange and secure with proper straps or u-bolts.

Pull front slip yoke back out ¾ inch to 1 inch to allow for end travel. (User's discretion, this can vary) Read the number on the Drive Shaft Measuring Tool at the reference point where the tape measure meets the telescopic tube. This will be your correct driveshaft center to center u-joint measurement to use to build a driveshaft.

1. I, Stephen D. Thomas, hereby claim that I have invented a tool that will be utilized in the aftermarket automotive industry. The automotive drive shaft measuring tool is used to measure the necessary length of the drive shaft in modified hot rod, off road, and other non-stock vehicle applications. This tool gives the user the exact measurements necessary to build a custom length drive shaft.
